(19) United States
(12) Patent Application Publication
(10) Pub. No.: US 2025/0042376 A1
(43) Pub. Date: Feb. 6, 2025

(54) BRAKING SYSTEM FOR AT LEAST ONE VEHICLE, SYSTEM AND PROCESS FOR THE CALIBRATION OF A BRAKING SYSTEM OF AT LEAST ONE VEHICLE, AND VEHICLE

(71) Applicant: Faiveley Transport Italia S.P.A., Piossasco (Torino) (IT)

(72) Inventor: Paolo Pietro PICCIONE, Piossasco (IT)

(73) Assignee: Faiveley Transport Italia S.P.A., Piossasco (Torino) (IT)

(21) Appl. No.: 18/769,803

(22) Filed: Jul. 11, 2024

(30) Foreign Application Priority Data
Jul. 11, 2023 (IT) 102023000014490

(51) Int. Cl. B60T 8/58; B60T 8/17; B60T 8/171; B60T 8/172; B60T 8/18; B60T 13/66; B60T 13/74; B61H 1/00

(52) U.S. Cl. CPC B60T 8/58; B60T 8/1705; B60T 8/171; B60T 8/172; B60T 8/1806; B61H 1/003; B60T 13/662; B60T 13/746; B60T 2210/12; B60T 2250/02; B60T 2250/04

(57) ABSTRACT

A braking system (200) is described for at least one vehicle (V), particularly at least one railway vehicle, comprising control means arranged to:
a) determine a real instantaneous deceleration value of the vehicle during the actuation of braking means (202);
b) determine a real friction value between braking means and at least one wheel or at least one disc, as a function of at least said real instantaneous deceleration value, a test mass value of the vehicle and a value of an actuation signal;
c) replace a predetermined expected friction value stored in the storage medium (210, 210′) with the determined real friction value.

Further described is a system for calibrating a braking system of at least one vehicle, and a process for calibrating a braking system of at least one vehicle (V), and vehicles.

### TECHNICAL SECTOR

This invention falls within the automotive industry in general; the invention particularly relates to a braking system for at least one vehicle, a system for calibrating the braking system of at least one vehicle, and the process for calibrating a braking system in at least one vehicle.

### KNOWN TECHNIQUE

The known technique will be described below with main reference to the automotive railway sector. However, what is described below can also be applied (similarly) to vehicles in other sectors.

In braking systems for railway vehicles, the calibration (tuning) of braking parameters during dynamic field tests is a known technique. This tuning is done before the vehicle is put into service.

The tuning of braking parameters has the aim of making the vehicle's braking performance meet design performance requirements, such as average deceleration, instantaneous deceleration and stopping distances.

In particular, tuning involves different types of braking: service braking, emergency braking, rescue braking and other possible types of braking that use the braking system as a means of applying brakes in a railway vehicle.

For example, the braking system may be a pneumatic or electro pneumatic braking system, which can stop/slow down the vehicle by actuating braking means. As can be seen in FIG. 1, the braking means 100 can include for example at least one braking application element, also called “friction lining”. The braking application element can be for example a shoe 102, in the case of a system that uses the “shoe” brake, or a brake pad 104, in the case of a system that uses the “disc” brake.

The braking element can be suitably pushed, by means of pneumatic pressure acting on a piston that implements the braking force, onto a specific element, such as a brake disc 106, in the case of a system that uses the “disc” brake, or a wheel W, in the case of a system that uses the “shoe” brake.

Such a braking element may be pushed, by the aforementioned pneumatic pressure, onto the disc or wheel, so as to produce a braking force by means of the known friction phenomenon, caused by the sliding between bodies in relative motion. The bodies in relative motion are therefore the braking application element, for example attached to the railway carriage, and the brake disc (in the case of a disc brake) or the wheel attached to a rotating railway axle 108.

One of the above braking parameters concerns specifically the friction value between said braking means and the wheel or disc.

In the known technique, the tuning of this parameter is carried out through manual modification by qualified and authorized personnel, the friction value residing in braking software/control means during dynamic testing of the vehicle. A similar tuning procedure can also be envisaged for the other braking parameters. The aforementioned friction value between the braking means and the disc or wheel can also impact other braking parameters directly connected to it.

It is known that the modification of said braking parameters has a direct effect on the braking pressure that acts inside pistons residing in cylinders, called braking means brake cylinders. The pistons, driven by said braking pressure, act on the braking application elements, which are then pushed onto the discs or wheels of the railway vehicle, producing a braking force, responsible for slowing down and consequent stopping of the railway vehicle.

The aforementioned tuning of the braking parameters during dynamic tests of a railway vehicle has the main limitation of using a manual procedure in the definition of the braking parameters by the competent personnel in charge. The consequent impact is defined by the risk of human error due to the manual nature of the procedure, together with greater time spent in the tuning of braking parameters.

In addition, calibration parameters should be reviewed during the life of the vehicle due to wear of the braking means. However, since the above tuning procedures are not automated but require specific manual testing performed in the field, should these braking parameters need to be recalibrated, the vehicle must be taken out of service.

### SUMMARY OF THE INVENTION

It is an objective of this invention to provide a solution that allows a reduction in the time required for calibration of the braking parameter relating to the friction value between the braking means and at least one wheel or at least one disc associated with the wheel or axle of the vehicle.

A further objective of this invention is to provide a solution that reduces the time spent in calibrating the braking parameter relating to the friction value between the braking means and at least one wheel or at least one disc associated with the wheel or axle.

A further objective of this invention is to provide a solution that allows automated tuning of the braking parameter relating to the friction value between the braking means and at least one wheel or at least one disc associated with the wheel or axle, even after commissioning of the vehicle.

These and other purposes and benefits are achieved, according to one aspect of the invention, by a braking system having the characteristics defined in Claim 1, by a system for calibrating a braking system of at least one vehicle having the features defined in Claim 12, by a process for calibrating a braking system of at least one vehicle having the features defined in Claim 14 and of a vehicle having the features defined in Claim 16 or 17. Preferred invention implementation forms are defined in the dependent claims, the content of which is understood to be an integral part of this description.

In summary, this invention is intended to replace, via an automated solution, the manual procedure of tuning the braking parameter relating to the friction value between the braking means and the wheel or disc associated with the wheel or axle.

### BRIEF DESCRIPTION OF THE DRAWINGS

The functional and structural features of some preferred implementations of a braking system of at least one vehicle, a system for calibrating a braking system, a process for calibrating a braking system and a vehicle according to the invention will now be described. Reference is made to the accompanying drawings, in which:

FIG. 1 shows examples of braking means according to known technique;

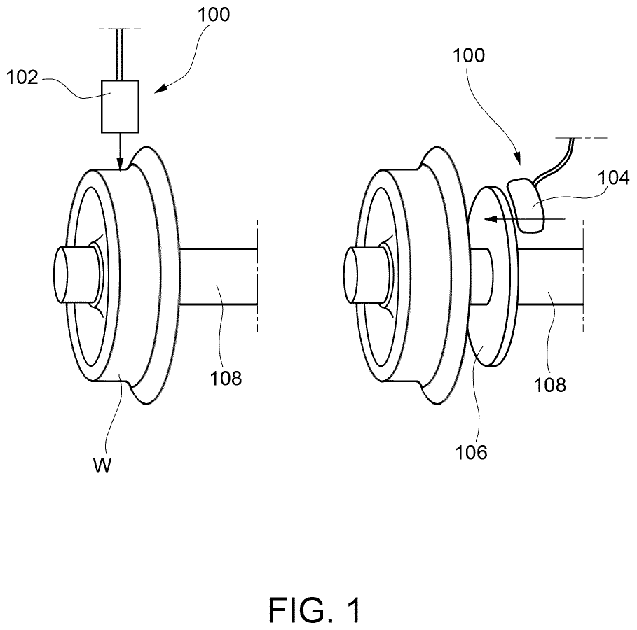

FIG. 2 shows a first embodiment of a braking system according to the invention;

FIGS. 3a and 3b show respective illustrative embodiments, wherein the braking means comprises a plurality of braking application means;

FIG. 4 shows in detail an illustrative detachment condition C1 of the braking means and an illustrative contact condition C2 of the braking means;

FIG. 5 shows a further embodiment of a braking system according to the invention;

FIG. 6 shows an embodiment of a system for calibrating a braking system;

FIG. 7 shows a further embodiment of a system for calibrating a braking system.

### DETAILED DESCRIPTION

Before explaining in detail the plurality of what the invention embodies, it should be clarified that the invention is not limited in its application to construction details and configuration of components presented in the following description or illustrated in the drawings. The invention is capable of taking on other embodiments and being practically implemented or realized in different ways. It should also be understood that phraseology and terminology are descriptive and should not be construed as limiting. The use of “include” and “comprise” and their variations is intended to include the elements stated below and their equivalents, as well as additional elements and their equivalents.

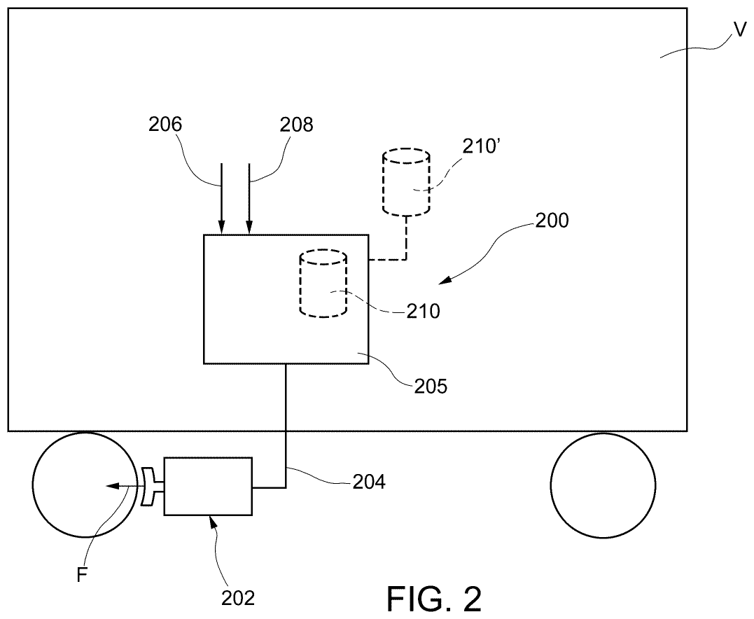

Referring initially to FIG. 2, the first embodiment of a braking system for at least one vehicle, particularly at least one rail vehicle, is described below.

In this first embodiment, the braking system 200 comprises braking means 202 arranged to receive an actuation signal and to apply a corresponding braking force F to at least one wheel of said vehicle or at least one disc to which at least one wheel or axle of said vehicle is associated.

The intensity value of the braking force F applied by the braking means 202 is a function of the value of the actuation signal 204.

In other words, the intensity of the braking force F applied by the braking means 202 is a function of the value given by the actuation signal 204. For example, the greater the value given by the actuation signal 204, the greater the intensity of the braking force applied by the braking means, or vice-versa.

The braking system 200 further comprises control means 205.

For example, the control means 205 can be or comprise at least one of: a controller, a processor, a microprocessor, a microcontroller, at least one PLC, an FPGA, or the like.

The control means 205 is arranged to:
receive a test braking request 206, indicative of an expected instantaneous deceleration value;
determine the value of the actuation signal 204 which allows the braking means 202 to apply, to at least one wheel or to at least one disc, a braking force F having an intensity value such that at least one said vehicle would be decelerated according to said expected instantaneous deceleration value;
actuate the braking means 202 according to the determined value of the actuation signal 204.

In other words, the value of the determined actuation signal 204 is the value that would cause said braking means 202 to apply to at least one wheel or to at least one disc; a braking force F having a value of intensity such that at least one vehicle would be decelerated according to the expected instantaneous deceleration value.

The control means 205 is arranged to determine the value of the actuation signal 204 as a function of at least a predetermined expected friction value between the braking means 202 and at least one wheel or at least one disc, with a test mass value of at least one vehicle 208, with the expected instantaneous deceleration value.

The predetermined expected friction value between the braking means 202 and at least one wheel or one disc is arranged to be stored at storage media 210 comprised in control means 205 or storage media 210′ associated with control means 205.

The control means 205 is further arranged to:
a) determine a real instantaneous deceleration value of the vehicle during actuation of the braking means 202;
b) determine a real friction value between the braking means 202 and at least one wheel or at least one disc, depending at least on the real instantaneous deceleration value, the test mass value of the vehicle and the actuation signal value;
c) replace the predetermined expected friction value stored in the storage media 210, 210′ with the determined real friction value.

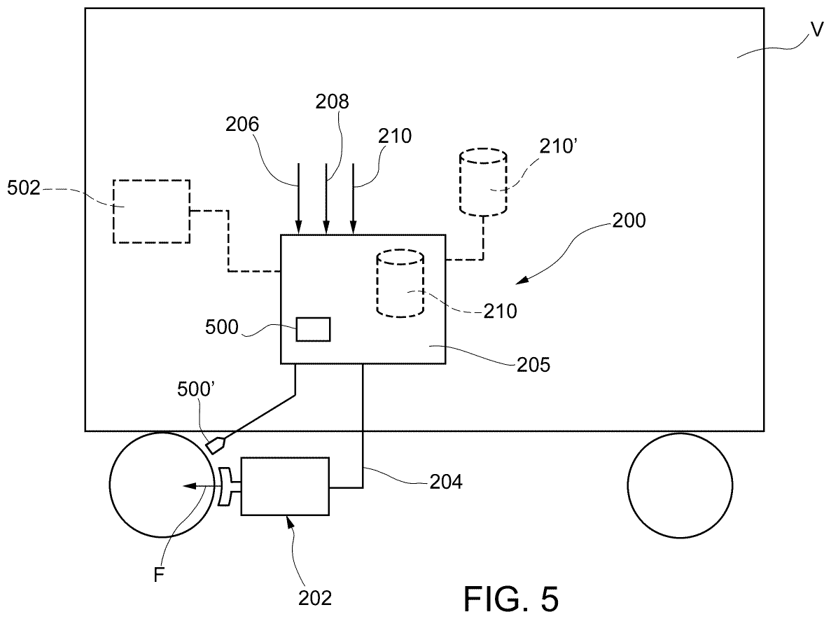

For example, to determine the actual instantaneous deceleration value of the vehicle, the control means 205 can comprise or be associated with speed sensor means (see FIG. 5: 500, 500′) arranged to determine the actual forward speed of the vehicle. The speed sensor means can be or comprise, for example, at least one rotation sensor arranged to measure the rotational speed of a wheel or axle of the vehicle. Or, the control means 205 can be arranged to receive actual forward speed data from further control means external to the braking system.

With regard to the test mass value of the vehicle, the control means 205 can comprise or be associated with weighing means arranged to determine the mass of the vehicle. For example, the weighing means can determine the mass of the vehicle via deformation sensor means or by monitoring the vehicle suspension. Or, the control means 205 can receive mass data from further control means external to the braking system. Alternatively, the test mass value can be entered manually by a user, for example via a keyboard.

Due to the fact that at the end of the calibration procedure the predetermined stored expected friction value is replaced by the determined real friction value, the control means 205, when having to re-determine the value of the actuation signal 204 for the braking means 202, can take into account the determined real friction value and not the predetermined one (which was not consistent with the actual friction situation).

Preferably, the control means 205 can further be arranged to determine said actuation signal 204 value as a function of at least one predetermined test condition. In that case, the control means 205 can further be arranged to verify that at least one predetermined test condition is met.

Furthermore, the control means 205 can be arranged to perform the above steps a), b), and c) when the control means 205 determines that at least one said predetermined test condition is met.

Preferably, at least one predetermined test condition can be a predetermined test forward speed. In that case, as already explained above and as for example observable in FIG. 5, the control means 205 of the braking system 200 can comprise speed sensor means 500 or be associated with at least speed sensor means 500′ arranged to measure the actual forward speed. Otherwise, the control means 205 of the braking system can be arranged to receive actual forward speed data from further control means 502 external to the braking system. Furthermore, the control means 205 can be arranged to determine that the predetermined test condition is met when the predetermined forward speed and the actual forward speed are substantially coincident.

Preferably, at least one predetermined test condition can be a predetermined test grip value between at least one wheel of the vehicle and a running surface. In that case, the control means 205 of the braking system can comprise grip determining means or be associated with grip determining means arranged to measure the actual grip value. Or, the control means 205 of the braking system can be arranged to receive an actual grip value between at least one wheel of the vehicle and a running surface from further control means external to the braking system. Furthermore, the control means can be arranged to determine that the predetermined test condition is met when the predetermined test grip value and the actual grip value are substantially coincident.

Preferably, the control means 205 can further be arranged to:
receive a request for service braking;
actuate the braking means 202 via an actuation signal having a value determined as a function of said real friction value determined and adapted to apply a service braking force corresponding to the received service braking request to said braking means 202.

In other words, following calibration of the determined real friction value, the control means 205 of the braking system 200 can take into account this calibrated real friction value for control of the service braking that will be performed by the braking system.

Alternatively or in addition, the control means 205 can further be arranged to:
receive an emergency braking request;
actuate said braking means 202 via an actuation signal 204 having a value determined as a function of the determined real friction value and adapted to apply to said braking means an emergency braking force corresponding to the received emergency braking request.

In other words, following calibration of the determined real friction value, the control means 205 of the braking system 200 can manage the actuation of the emergency braking that will be performed by the braking system. Emergency braking can also be managed according to the calibrated real friction value.

By way of non-limiting example, the control means 205 can be arranged to determine the real friction value between the braking means and at least one wheel or at least one disc, via the following formula:

$${μ}_{reale} = \frac{m * {a}_{inst \_ reale}}{{A}_{sig}}$$

wherein μᵣₑₐₗₑ is the true friction value, m is the test mass value of that vehicle, a_{inst_reale} is the real instantaneous deceleration value, and A_{sig} is the value of the actuation signal 204.

Similarly, the control means 205 can be arranged to determine the value of the actuation signal 204 via the following formula:

$${A}_{sig} = \frac{m * {a}_{test}}{{μ}_{pred}}$$

wherein A_{sig} is the value of the actuation signal 204, m is the test mass value of that vehicle, aₜₑₛₜ is the expected instantaneous deceleration value and μ_{pred} is the predetermined expected friction value.

Preferably, the intensity value of the braking force F converted by the braking means can be dependent on a characterization parameter specific to said braking means.

In that case, the control means 205 can further be arranged to:
determine the value of the actuation signal as a function of the characterization parameter of said braking means;
determine the real friction value between said braking means and at least one said wheel or at least one said disc, also depending on the characterization parameter specific to said braking means.

For example, the value assumed by the braking system characterization parameter can depend on one or more of the following characterizing factors:
geometry of braking means;
multiplicity of braking means;
efficiency of braking means.

For example, the geometry of the braking means can comprise one or more of the following parameters:
a braking radius of a braking means disc braking system, a spoke of a wheel to which said braking means will apply the braking force, a surface of the breaking means' braking cylinder's braking piston, amplification ratio of the braking force generated by levers of the braking means, etc.

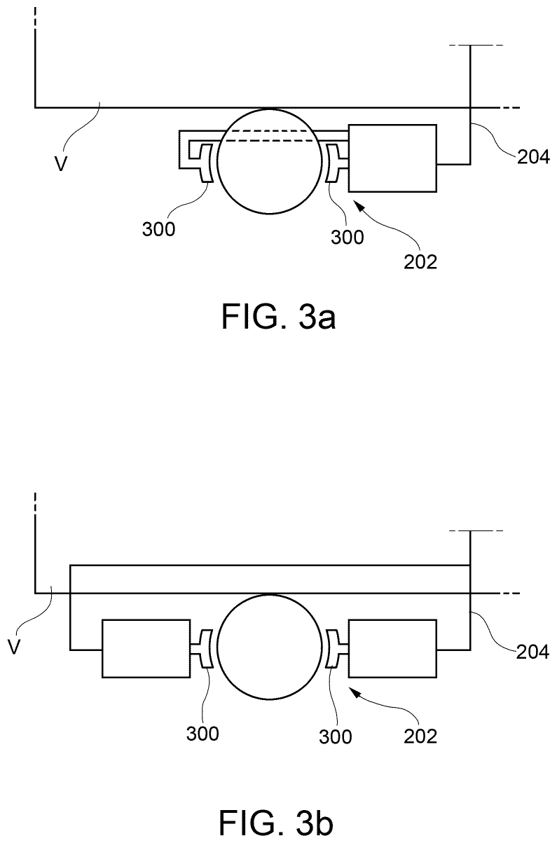

For example, the multiplicity of the braking means can include the number of the braking means' braking application means. For example, as seen in FIGS. 3a and 3b, the braking means 202 can comprise a plurality of braking application elements 300. For example, the braking application means 300 can comprise or be at least one of: a brake pad or braking shoe, or similar (friction lining).

For example, efficiency of the braking means can signify a value indicative of the ability of the braking means to apply a braking force in light of any force losses/dispersions due to the mechanical-structural characteristics of the braking means.

Preferably, the control means 205 can further be arranged to:
determine the value of the actuation signal 204 also as a function of an initial activation value;
determine the real friction value between the braking means 202 and at least one wheel or at least one axle or at least one disc, also depending on that initial activation value.

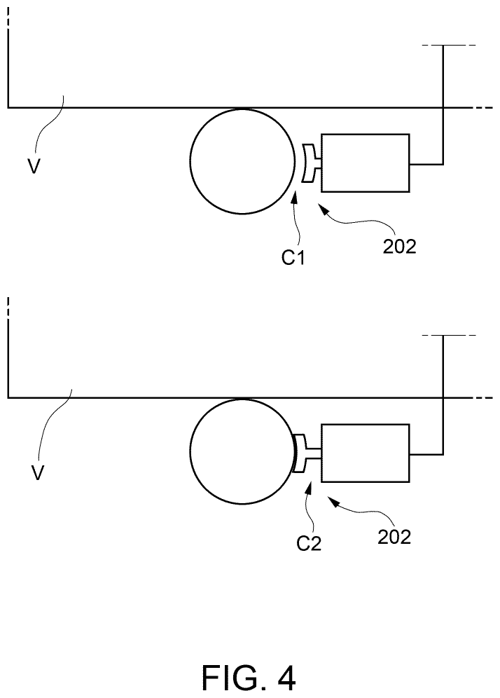

In particular, as seen for example in FIG. 4, the initial activation value may have a value such that, when provided to the braking means 202, allows/causes said braking means 202 to transition from a detachment condition C1 in which it does not contact at least one wheel or axle or disc, to a contact condition C2 in which it contacts at least one wheel or axle or disc.

Preferably, when both the characterization parameter k and the initial activation value q are provided, the control means 205 can be arranged to determine the real friction value between said braking means 202 and at least one said wheel or at least one said disc, via the following formula:

$${μ}_{reale} = \frac{m * {a}_{{inst}_{reale}} * k}{( {A}_{sig} - q )}$$

wherein μᵣₑₐₗₑ is the true friction value, m is the test mass value of that vehicle, a_{inst_reale} is the real instantaneous deceleration value, k is the braking means characterization parameter, A_{sig} is the actuation signal value and q is the initial actuation value.

Clearly, the characterization parameter k can take a value equal to 1, and the initial activation value q can take a value equal to 0.

Similarly, the control means 205 can be arranged to determine the value of the actuation signal 204 via the following formula:

$${A}_{sig} = \frac{m * {a}_{test} * k}{{μ}_{pred}} + q$$

wherein A_{sig} is the value of the actuation signal 204, m is the test mass value of that vehicle, aₜₑₛₜ is the expected instantaneous deceleration value, k is the characterization parameter, μ_{pred} is the predetermined expected friction value, and q is the initial actuation value.

Preferably, the braking means 202 can be pneumatic and the determined actuation signal value can be a pneumatic pressure value.

Or, the braking means 202 can be electro pneumatic or electromechanical and the value of the determined actuation signal can be an electrical value.

In a further aspect, this invention also concerns a system for calibrating a braking system of at least one vehicle, particularly at least one railway vehicle.

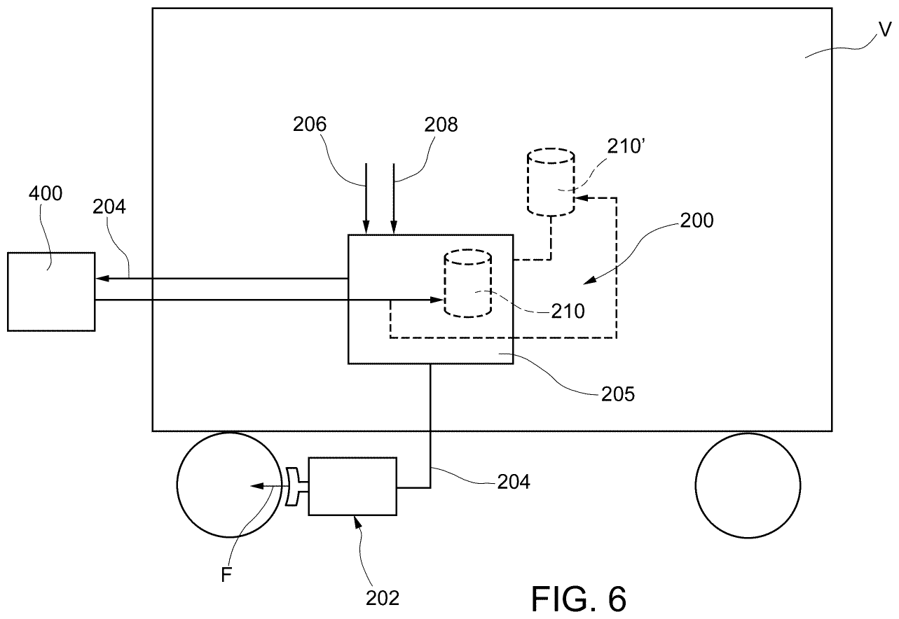

As can be seen in FIG. 6, the braking system 200 again comprises braking means arranged to receive an actuation signal and apply a corresponding braking force to at least one wheel of said vehicle or at least one disc to which at least one wheel or axle of said vehicle is associated. The intensity value of the braking force applied by the braking means 202 is a function of a value of the actuation signal 204.

The braking system 200 comprises control means 205 arranged to:
receive a test braking request 206, indicative of an expected instantaneous deceleration value;
determine the value of said actuation signal 204 which allows said braking means 202 to apply a braking force intensity value to at least one said wheel or at least one said disc, such that at least one said vehicle would be decelerated according to said expected instantaneous deceleration value;
actuate the braking means 202 according to the determined value of the actuation signal 204.

The control means 205 is further arranged to determine the value of said actuation signal 204 as a function of at least a predetermined expected friction value between the braking means and at least one wheel or at least one disc, of a test mass value of at least one vehicle, and of the value of said expected instantaneous deceleration.

The predetermined expected friction value between the braking means 202 and at least one wheel or at least one disc is arranged to be stored in storage media 210 comprised in the control means 205 of the braking system or in storage media 210′ associated with the braking system control means 205.

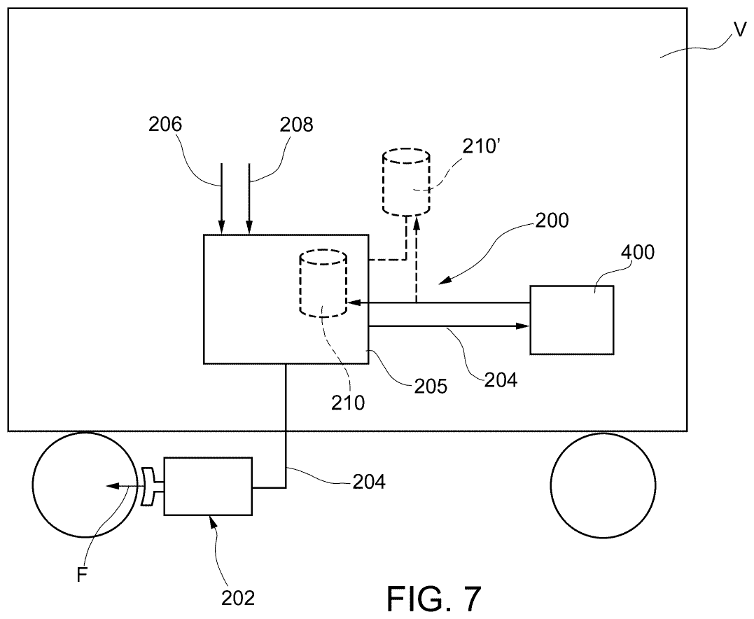

As can be seen in FIG. 6 or FIG. 7, the calibration system comprises calibration control means 400 arranged to be associated with the braking system 200 of at least one vehicle and receive the value of the actuation signal 204 determined by the control means of the braking system.

Preferably, the calibration control means 400 can be or comprise at least one of: a controller, a processor, a microprocessor, a microcontroller, at least one PLC, an FPGA, or the like.

The calibration control means 400 is further arranged to:
a) determine a real instantaneous deceleration value of the vehicle during actuation of the braking means 202 according to said value of the actuation signal 204;
b) determine a real friction value between the braking means and at least one wheel or at least one disc, depending at least on the real instantaneous deceleration value, the test mass value of that vehicle 208 and the value of the actuation signal 204;
c) replace the predetermined expected friction value stored in the storage media 210, 210′ with the determined real friction value.

For example, to determine the actual instantaneous deceleration value of the vehicle, the calibration control means 400 can comprise or be associated with speed sensor means (not shown in the figure) arranged to determine the actual vehicle forward speed. The speed sensor means can be or comprise of, for example, at least one rotation sensor arranged to measure the rotational speed of a wheel or axle of the vehicle. Or, the calibration control means 400 can be arranged to receive actual forward speed data directly from the control means 205 of the braking system or from further control means external to the calibration system and the braking system.

With regard to the vehicle test mass value, the calibration control means 400 may comprise or be associated with weighing means arranged to determine the mass of the vehicle. For example, the weighing means can determine the mass of the vehicle via deformation sensor means or by monitoring the vehicle suspension. Or, the calibration control means 400 can receive the mass data directly from the control means 205 of the braking system, or from further control means external to the calibration system and the braking system. As a further alternative, the test mass value can be entered manually by a user, for example via a keyboard.

Preferably, the control means 205 of the braking system 200 can further be arranged to determine the value of the actuation signal 204 as a function of at least one predetermined test condition.

In that case, the calibration control means 400 of the calibration system can further be arranged to verify that at least one predetermined test condition is met.

The calibration control means 400 can therefore be arranged to perform the above steps a), b), and c) when the calibration control means 400 determines that at least one predetermined test condition is met.

Preferably, at least one predetermined test condition can be a predetermined test forward speed. In that case, the calibration control means 400 of the calibration system can comprise speed sensor means or be associated at least with speed sensor means (not shown in the figure) arranged to measure actual forward speed. Or, the calibration system's calibration control means 400 can be arranged to receive actual forward speed data from additional control means external to the calibration system or directly from the control means 205 of the braking system. Furthermore, the calibration system's calibration control means 400 can be arranged to determine that the predetermined test condition is met when the predetermined test forward speed and the actual forward speed substantially coincides.

Preferably, at least one predetermined test condition can be a predetermined test grip value between at least one wheel of the vehicle and a running surface. In that case, the calibration system's calibration control means 400 can comprise grip determination means or be associated with grip determination means arranged to measure an actual grip value. Alternatively, the calibration system's calibration control means 400 can be arranged to receive an actual grip value between at least one wheel of the vehicle and a running surface by further control means external to the calibration system or directly from the braking system's control means 205. Furthermore, the calibration system's calibration control means can be arranged to determine that the predetermined test condition is met when the predetermined test grip value and the actual grip value substantially coincides.

The preferred embodiments described above for the braking system 200 can find similar application for the calibration system.

By way of non-limiting example, the calibration control means 400 can be arranged to determine the true friction value between the braking means and at least one wheel, one axle or one disc, via the following formula:

$${μ}_{reale} = \frac{m * {a}_{inst \_ reale}}{{A}_{sig}}$$

wherein μᵣₑₐₗₑ is the real friction value, m is the test mass value of that vehicle, a_{inst_reale} is the real instantaneous deceleration value, and A_{sig} is the actuation signal value.

Preferably, the intensity value of the braking force F converted by the braking means can be dependent on a characterization parameter specific to said braking means. The description of the characterization parameter provided above, and not repeated here, can similarly apply in this context as well.

Preferably, the calibration control means 400 can further be arranged to determine the real friction value between said braking means and at least one said wheel or at least one said disc, also depending on that initial activation value. Wherein the initial activation value can have a value such that, when provided to the braking means, allows/causes said braking means to transition from a detachment condition C1 in which it does not contact at least one wheel or at least one axle or at least one disc, to a contact condition C2 in which it contacts at least one wheel or at least one axle or at least one disc.

Preferably, when both the characterization parameter k and the initial actuation value q are present, the calibration control means 400 can be arranged to determine the real friction value between said braking means 202 and at least one said wheel or at least one said axle or at least one said disc, via the following formula:

$${μ}_{reale} = \frac{m * {a}_{{inst}_{reale}} * k}{( {A}_{sig} - q )}$$

wherein μᵣₑₐₗₑ is the true friction value, m is the test mass value of that vehicle, a_{inst_reale} is the real instantaneous deceleration value, A_{sig} is the actuation signal value, k is the characterization parameter and q is the initial actuation value.

For example, the calibration system's calibration control means 400 can be arranged to cooperate with the control means 205 of the braking system. For example, the calibration system can be installed directly in the vehicle (as seen in FIG. 7) or it can be external to the vehicle and connected to the braking system during calibration and can be disconnected from the braking system at the end of calibration (as seen in FIG. 6).

In still further aspect, this invention relates to a process for calibrating a braking system 200 of at least one vehicle, particularly at least one railway vehicle, performed/actuated via control means.

For example, the control means can be or comprise the braking system's control means 205 and/or the calibration system's calibration control means 400.

Again, the braking system 200 comprises braking means 202 arranged to receive an actuation signal 204 and apply a corresponding braking force F to at least one wheel or axle of said vehicle or at least one disc to which at least one wheel or axle of said vehicle is associated. A braking force intensity value applied by the braking means 202 is a function of a value of said actuation signal 204.

The calibration process includes the steps:
receive a test braking request 206, indicative of an expected instantaneous deceleration value;
determine the value of the actuation signal 204 which allows the braking means 202 to apply a braking force intensity value to at least one wheel or to at least one axle or to at least one disc, such that at least one said vehicle would be decelerated according to said expected instantaneous deceleration value, as a function of at least a predetermined expected friction value stored in storage media 210, 210′ between said braking means and at least one said wheel or at least one said disc, of a test mass value of at least one vehicle, and of the value of said expected instant deceleration;
actuate said braking means 202 according to the determined value of the actuation signal 204.

The calibration process also includes the steps:
a) determine the real instantaneous deceleration value of the vehicle during actuation of said braking means 202 according to the value of said actuation signal;
b) determine the real friction value between said braking means and at least one said wheel or at least one said disc, as a function of at least said real instantaneous deceleration value, the test mass value of that vehicle and said actuation signal value;
c) replace the predetermined expected friction value stored in the storage media 210, 210′ with the determined real friction value.

Preferably, the step of determining the value of said actuation signal can also be carried out according to at least one predetermined test condition. In this case, the calibration process can also include the step:
verify that at least one said predetermined test condition is met;
wherein steps a), b) and c) are performed when the verification shows at least one said predetermined test condition is met.

As explained above, the predetermined test condition can relate to the verification of a predetermined test forward speed or predetermined test grip value between at least one vehicle wheel and a running surface.

The preferred embodiments described above for the braking system and the calibration system can find similar application for the calibration process.

For example, step b) can comprise determining the real friction value between the braking means and at least one wheel or at least one axle or at least one disc, via the following formula:

$${μ}_{reale} = \frac{m * {a}_{inst \_ reale}}{{A}_{sig}}$$

wherein μᵣₑₐₗₑ is the real friction value, m is the test mass value of that vehicle, a_{inst_reale} is the real instantaneous deceleration value, and A_{sig} is the actuation signal value.

In a further example, step b) can comprise determining the real friction value between the braking means and at least one wheel or at least one axle or at least one disc, via the following formula:

$${μ}_{reale} = \frac{m * {a}_{{inst}_{reale}} * k}{( {A}_{sig} - q )}$$

wherein μᵣₑₐₗₑ is the true friction value, m is the test mass value of that vehicle, a_{inst_reale} is the real instantaneous deceleration value, A_{sig} is the actuation signal value, k is the characterization parameter and q is the initial actuation value.

The explanations provided above for the characterization parameter and the initial actuation value are similar in application and are not repeated here.

In addition, this invention also relates to a vehicle, particularly a railway vehicle. In particular, the vehicle can be for example a railway vehicle and comprise a braking system according to any of the embodiments described above.

In a further embodiment, the vehicle comprises of a braking system and a system for calibrating the braking system of at least one vehicle, according to any one of the embodiments described above.

Preferably, this invention can be particularly applicable to the sector of rail vehicles/convoys that travel on railway tracks. A convoy can be understood as a plurality of vehicles interconnected with each other. A convoy can be a train.

For example, a vehicle referred to herein can be a locomotive or a carriage, and a route/segment can comprise rails (running surface) on which the locomotive wheels roll. However, the embodiments described herein are not to be understood as limited to rail vehicles. For example, the vehicle can be an automobile, a truck (e.g., a highway semi-trailer, a mining truck, a logging truck, or the like), and the route can be a road or trail.

Preferably, the advantage achieved is that it has provided an automated solution for vehicle braking systems, which allows a reduction in the time required for braking system braking parameter tuning relative to the friction value between the braking means and the wheel or disc associated with the wheel.

A further advantage gained is that it has provided a solution that reduces the time taken to tune the braking system's braking parameter relative to the friction value between the braking means and the wheel or disc associated with the wheel.

Another advantage is that it has provided solutions that allow the predetermined expected friction value between the braking means and at least one wheel or at least one disc to be recalibrated during the operational life of the vehicle, without necessarily having to remove the vehicle from service for the intervention of a qualified operator.

According to the invention, various aspects and embodiments of a braking system, a system for calibrating a braking system of at least one vehicle, and a process for calibrating a braking system of at least one vehicle have been described. It is intended that each embodiment can be combined with any other embodiment. The invention is furthermore not limited to the described embodiments, but can be varied within the scope defined by the appended claims.

1. A braking system for a vehicle (V), wherein said braking system comprises a braking element to receive an actuation signal and apply a corresponding braking force (F) to at least one wheel of said vehicle or at least one disc of said vehicle;
wherein the braking force (F) applied by the braking element is a function of a value of said actuation signal;
the braking system further comprising a control circuit arranged to:
receive a test braking request, indicative of an expected instantaneous deceleration value;
determine the value of said actuation signal for applying the braking force (F) such that said vehicle would be decelerated according to said expected instantaneous deceleration value;
actuate said braking element according to the determined value of the actuation signal;
wherein said control circuit is arranged to determine said value of said actuation signal as a function of at least one of a predetermined expected friction value between said braking means and at least one said wheel or at least one said disc, a test mass value of the vehicle, or said expected instantaneous deceleration;
wherein said predetermined expected friction value between said braking means and at least one said wheel or at least one said disc is arranged to be stored in a storage media;
said control circuit further being arranged to:
a) determine a real instantaneous deceleration value of the vehicle during actuation of the braking element;
b) determine a real friction value between said braking element and at least one said wheel or at least one said disc as a function of at least said real instantaneous deceleration value, the test mass value of that vehicle, and said actuation signal value; and
c) replace the predetermined expected friction value stored in the storage media with the determined real friction value.

2. The braking system according to claim 1, wherein said control means is arranged to determine said value of the actuation signal as a function of at least one predetermined test condition;
said control circuit further being arranged to:
verify that at least one predetermined test condition is met;
wherein said control circuit is arranged to perform said steps a), b), and c) when said control means determines that at least one said predetermined test condition is met.

3. The braking system according to claim 1, wherein said control means is further arranged to at least one of:
receive a service braking request and actuate said braking means via an actuation signal having a value determined as a function of said real friction value determined and adapted to apply a service braking force corresponding to the received service braking request to said braking means; or
receive an emergency braking request and actuate said braking means via an actuation signal having a value determined as a function of said real friction value determined and adapted to apply an emergency braking force corresponding to the received emergency braking request to said braking means.

4. The braking system according claim 1, wherein the braking force (F) converted by the braking element based at least in part on a characterization parameter specific to said braking element;
wherein said control circuit is further arranged to:
determine the value of the actuation signal as a function of the characterization parameter of said braking element;
determine the real friction value between said braking element and at least one said wheel or at least one said disc based at least in part on the characterization parameter specific to said braking means.

5. The braking system according to claim 4, wherein the value of said characterization parameter of said braking element is a function of at least one of:
a geometry of the braking element;
a multiplicity of the braking element; or
an efficiency of the braking element.

6. The braking system according to claim 4, wherein said control means is further arranged to:
determine the value of the actuation signal further as a function of an initial activation value;
determine the real friction value between said braking element and at least one said wheel or at least one said disc based at least in part on the initial activation value;
wherein said initial activation value is such that, when provided to the braking element, allows said braking element to transition from a detachment condition (C1) in which it does not contact at least one wheel or disc, to a contact condition (C2) in which it contacts at least one wheel or disc.

7. The braking system according to claim 6, wherein said control circuit is arranged to determine the real friction value between said braking means and at least one said wheel or at least one said disc, via the following formula:
$${μ}_{reale} = \frac{m * {a}_{{inst}_{reale}} * k}{( {A}_{sig} - q )}$$
wherein μᵣₑₐₗₑ is the true friction value, m is the test mass value of that vehicle, a_{inst_reale} is the real instantaneous deceleration value, A_{sig} is the actuation signal value, k is the braking means characterization parameter and q is the initial actuation value.

8. The braking system according to claim 7, wherein said braking element is pneumatic and the determined actuation signal value is a pneumatic pressure value.

9. The braking system according to claim 1, wherein said braking element is electro pneumatic or electromechanical and the determined actuation signal value is an electrical signal.

10. The braking system according to claim 2, wherein the at least one predetermined test condition comprises a predetermined test forward speed;
wherein said control circuit comprises a speed sensor arranged to measure an actual forward speed;
or
wherein said control circuit is arranged to receive actual forward speed data from another control circuit external to the braking system;
said control circuit being arranged to determine that the predetermined test condition is met when the predetermined test forward speed and the actual forward speed are substantially coincident.

11. The braking system according to claim 2, wherein the at least one predetermined test condition comprises a predetermined test grip value between at least one wheel of the vehicle and a running surface;
wherein said control circuit comprises a comprises a grip sensor arranged to measure an actual grip value;
or
wherein said control circuit is arranged to receive an actual grip value between at least one wheel of the vehicle and a running surface from another control circuit external to the braking system;
said control circuit being arranged to determine that the predetermined test condition is met when the predetermined test grip value and the actual grip value are substantially coincident.

12. A system for calibrating a braking system of a vehicle wherein said braking system comprises a braking element arranged to receive an actuation signal and apply a corresponding braking force (F) to at least one wheel of said vehicle or at least one disc of said vehicle;
wherein the braking force (F) applied by the braking means is a function of a value of said actuation signal;
the braking system also comprising of a control circuit arranged to:
receive a test braking request indicative of an expected instantaneous deceleration value;
determine the value of said actuation signal to apply the braking force (F) such that the vehicle would be decelerated according to said expected instantaneous deceleration value;
actuate said braking element according to the determined value of the actuation signal;
wherein said control circuit is arranged to determine the value of said actuation signal as a function of at least a predetermined expected friction value between said braking element, a test mass value of at least one vehicle, and said expected instantaneous deceleration;
wherein said predetermined expected friction value between said braking element and at least one said wheel or at least one said disc is arranged to be stored in a storage media;
said system for calibrating a braking system comprising calibration circuit arranged to be associated with said braking system of at least one vehicle (V) and to:
receive the value of the actuation signal determined by the control circuit;
said calibration circuit further being arranged to:
a) determine a real instantaneous vehicle deceleration value during actuation of said braking means according to said value of the actuation signal;
b) determine a real friction value between said braking element and at least one said wheel or at least one said disc as a function of at least said real instantaneous deceleration value, the test mass value of that vehicle, and said actuation signal value;
c) replace the predetermined expected friction value stored in the storage media with the determined real friction value.

13. The system for calibrating a braking system according to claim 12, wherein control circuit is arranged to determine said actuation signal value as a function of at least one predetermined test condition;
wherein said calibration circuit of a braking system's calibration system is further arranged to:
verify that at least one predetermined test condition is met;
wherein said calibration circuit is further arranged to perform said steps a), b), and c) when said calibration circuit determines that at least one said predetermined test condition is met.

14. A method for calibrating a braking system of at least one vehicle (V), wherein said braking system comprises a braking element arranged to receive an actuation signal and to apply a corresponding braking force (F) to at least one wheel of said vehicle or at least one disc of said vehicle;
wherein the braking force (F) applied by the braking element is a function of a value of said actuation signal;
the method comprising:
receiving a test braking request, indicative of an expected instantaneous deceleration value;
determining the value of said actuation signal to apply the braking force (F) such that at least one said vehicle would be decelerated according to said expected instantaneous deceleration value, as a function of at least one of a predetermined expected friction value stored in a storage media, a test mass value of at least one vehicle, or the value of said expected instant deceleration;
actuating said braking means (202) according to the determined actuation signal value;
a) determining a real instantaneous deceleration value of the vehicle during actuation of said braking element according to the value of said actuation signal;
b) determining a real friction value between said braking element and at least one said wheel or at least one said disc, as a function of at least said real instantaneous deceleration value, the test mass value of that vehicle, and said actuation signal value; and
c) replacing the predetermined expected friction value stored in the storage media with the determined real friction value.

15. The method according to claim 14, wherein the step of determining the value of said actuation signal is further carried out as a function of at least one predetermined test condition;
The method further comprising:
verifying that at least one said predetermined test condition is met;
wherein steps a), b) and c) are performed when the verification shows that at least one said predetermined test condition is met.

16. A vehicle comprising a braking system according to claim 1.

17. A vehicle comprising:
a braking system; and
a system for calibrating the braking system according to claim 12.
